(19) United States
(12) Patent Application Publication
(10) Pub. No.: US 2014/0108563 A1
(43) Pub. Date: Apr. 17, 2014

(54) Information Transmission Method Based on Classification of Electronic Device and Servo System

(71) Applicant: CHIDOPI CO., LTD., Taipei (TW)

(72) Inventors: Jason Hung, Taoyuan County (TW); Scott Shih, New Taipei City (TW)

(73) Assignee: CHIDOPI CO., LTD., Taipei City (TW)

(21) Appl. No.: 13/651,486

(22) Filed: Oct. 15, 2012

(51) Int. Cl. G06F 15/16

(52) U.S. Cl. 709/206

(57) ABSTRACT

An information transmission method, executed by a servo system, is provided that includes the following steps of: providing an application program to be downloaded, installed and executed in an electronic device, in which, after the electronic device executes the application program and a consent key is pressed, a device datum including the classification of the electronic device is sent to a servo system; recording the device datum in a user database; and pushing a push message corresponding to the classification of the electronic device to the electronic device.

### BACKGROUND OF THE INVENTION

1. Field of the Invention

The invention relates to an information transmission method and a servo system, in particular relates to an information transmission method based on a classification of an electronic device and a servo system.

2. Description of the Related Art

In recent decade, mobile communication industries have prosperously developed. It is very popular for users to use electronic devices such as smart mobile phones for networking via 3G network system or Wi-Fi. Based on communication functions of these electronic device, some dealers have applied signals produced from location update, dial-talking or roaming at device terminals to collect users' position coordinates, thereby analyzing the position coordinates for performing condition selection and then providing geographical location based service (LBS), such as detailed technical descriptions in Taiwan Patent Publication No. 200948037.

However, the present skills can merely collect the position coordinates at the device terminals and then transmit the position coordinates to related servo systems by a service dispatch module which provides an LBS related service to maintain the corresponding regions, such that the servo systems can transmit messages (e.g., activity messages of department stores) to the users. That is, the activity messages for the device terminals provided from the dealers according to the present skills can only be in connection with the geographical locations, such as providing promotion messages to one user from commercial area dealers when the user enters the commercial area. However, the user may be just a passenger passing by the commercial area, and the sent promotion message may possibly show meaningless to the user. Therefore, this marketing behavior has a very low hit rate.

Besides, in the present skills, the user can only send a dedicated code by text message in response to the received information and then input a particular code; however, it is not so applicable to the majority of users.

### BRIEF SUMMARY OF THE INVENTION

In view of this, the purpose of the invention is to provide an information transmission method based on a classification of an electronic device and a servo system. The invention can provide accurate services to users by using the classification of the electronic device which reveals users' groups and their favorite contents.

The invention provides an information transmission method based on a classification of an electronic device. The information transmission method comprises the following steps of: (A) providing an application program to be downloaded, installed and executed in the electronic device, in which, after the electronic device executes the application program and a consent key is pressed, a device datum comprising the classification of the electronic device is sent to a servo system; (B) recording the device datum in a user database; and (C) pushing a push message corresponding to the classification of the electronic device to the electronic device.

In step (A), after the application program is executed and the consent key is pressed, the electronic device sends positioning information along with time to the servo system; and in step (C) the push message pushed to the electronic device further corresponds to a position range determined in accordance with the positioning information.

The information transmission method based on the classification of the electronic device, prior to step (C), may further comprises step (D-1) of providing an information sending operation interface for an information sender to determine the position range to produce a range result, and step (D-2) of receiving the range result, wherein in step (C), the electronic device is located within the position range and the push message is pushed to the electronic device within the position range.

In step (C) the push message may be firstly transmitted to an electronic device supplier, and then the electronic device supplier transmits the push message to the electronic device.

The push message is preferably adopted with a universal network protocol and an extensible markup language format. The push message provides a plurality of options for a user to select, a selected option is sent to the servo system, and the servo system provides a next push message according to the selected option.

The invention also provides a servo system executing the information transmission method based on the classification of the electronic device.

By sending the push message based on the classification of the electronic device, the invention is capable of filtering most of spam messages to leave useful information to the users and performing an accurate and effective marketing behavior for advertisers.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a flowchart of an embodiment of an information transmission method based on a classification of an electronic device;

FIG. 2 is a schematic view of an information sending operation interface of the embodiment;

FIG. 3 is a schematic view of an inquiry window of the embodiment; and

FIG. 4 is a flowchart for executing questionnaire in accordance with the embodiment.

### DETAILED DESCRIPTION OF THE INVENTION

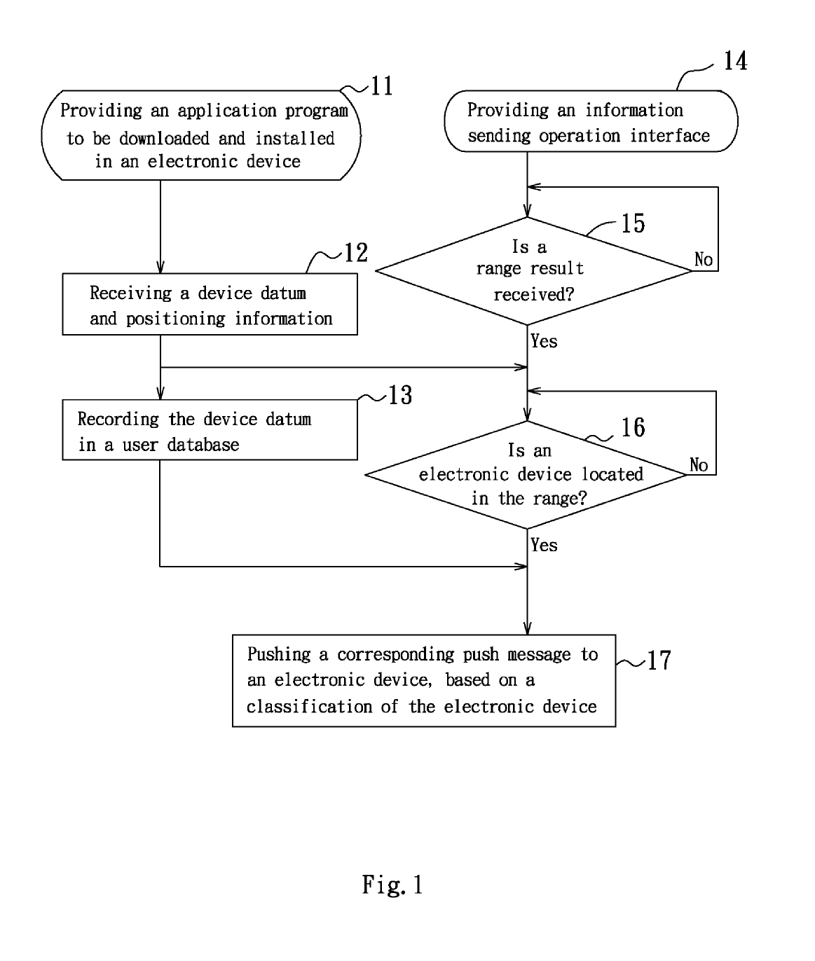

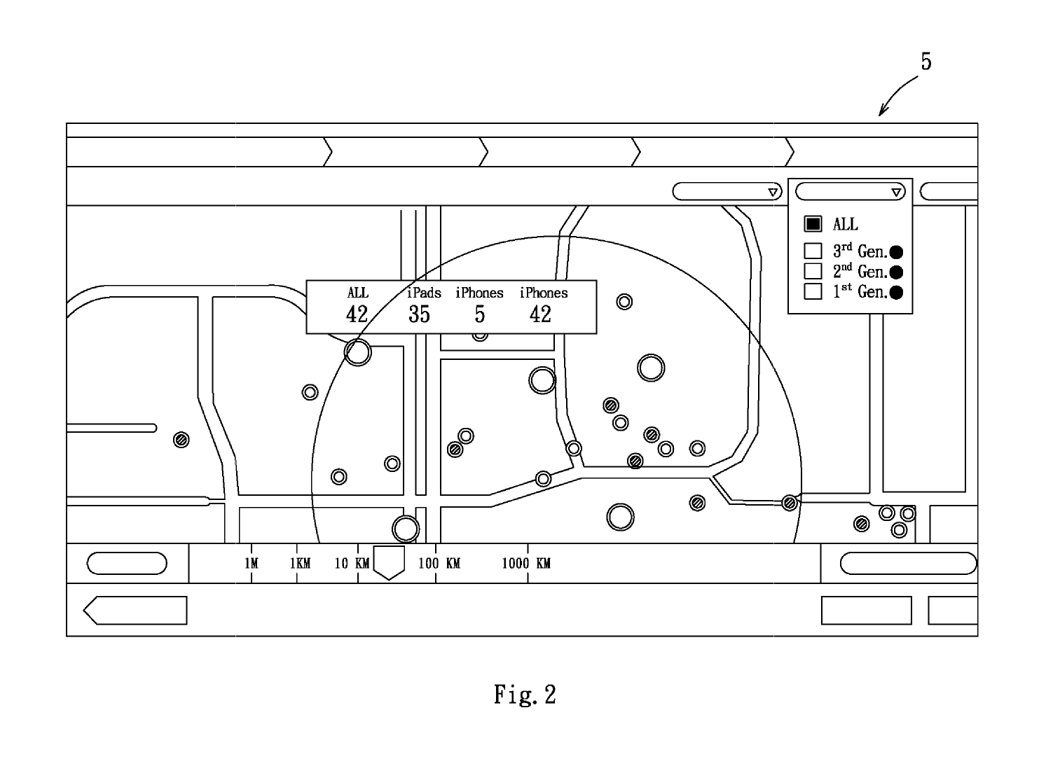

Referring to FIG. 1, an information transmission method based on a classification of an electronic device is executed by a servo system (not shown in Figs.). The servo system provides the electronic device with an application program for a user's downloading and installation (in step 11), and provides an information sending operation interface 5 as shown in FIG. 2 (in step 14) for an information sender to use via a computer. The electronic device of this embodiment is necessarily classifiable for representing a buyer's (the user's) preference(s), such as iPhone and iPod published by Apple Company or other high-level smart mobile phones.

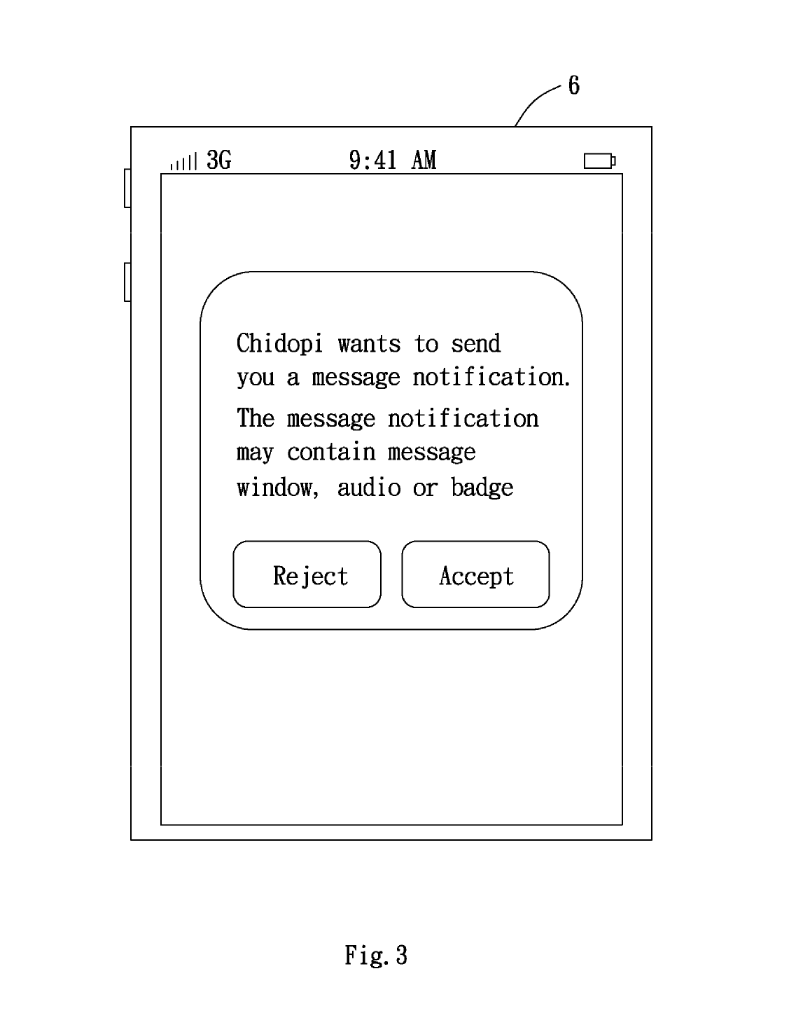

When the application program is installed and executed by the user, an inquiry window 6 is presented on the electronic device as shown in FIG. 3, inquiring whether the user is willing to receive the push message and provide a positioning information along with time or not. If the user consents to both by pressing consent keys of the electronic device, then a consent instruction for receiving a push message is sent to the servo system and a function of sending positioning information is ready to be performed.

The user transmits the consent instruction for receiving a push message to an electronic device supplier (not shown in Figs.). The electronic device supplier transmits an encrypted push message and device datum to the electronic device. Then, the latest positioning information, the received message and datum are packed and sent back to the servo system by the electronic device, wherein the device datum includes the classification of the electronic device.

The servo system receives the device datum and the positioning information which are packed together (step 12), and examines and records the device datum in a user database (step 13). Afterward, the electronic device is capable of updating the user database by sending new positioning information.

The information sender (e.g., an advertiser) is capable of using the information sending operation interface 5 shown in FIG. 2 to determine a position range to produce a range result.

After receiving the range result (step 15), the servo system reads the positioning information obtained in step 12 to determine whether the electronic device appears in the position range or not (step 16). In practical application, a plurality of electronic devices with the application programs of the invention installed therein may simultaneously appear in the position range. In step 16, therefore, all the positioning information and the determined position range are checked to identify if there are any electronic devices appearing in the determined position range.

In step 17, based on the classification of the electronic device appearing in the determined position range, the push message that contains the classification of the electronic device and the position range is pushed to the electronic device. Specifically, in the pushing process, the servo system firstly transmits the push message to the electronic device supplier, in the predetermined format acceptable by the electronic device supplier, and then the electronic device supplier transmits the push message to the electronic device.

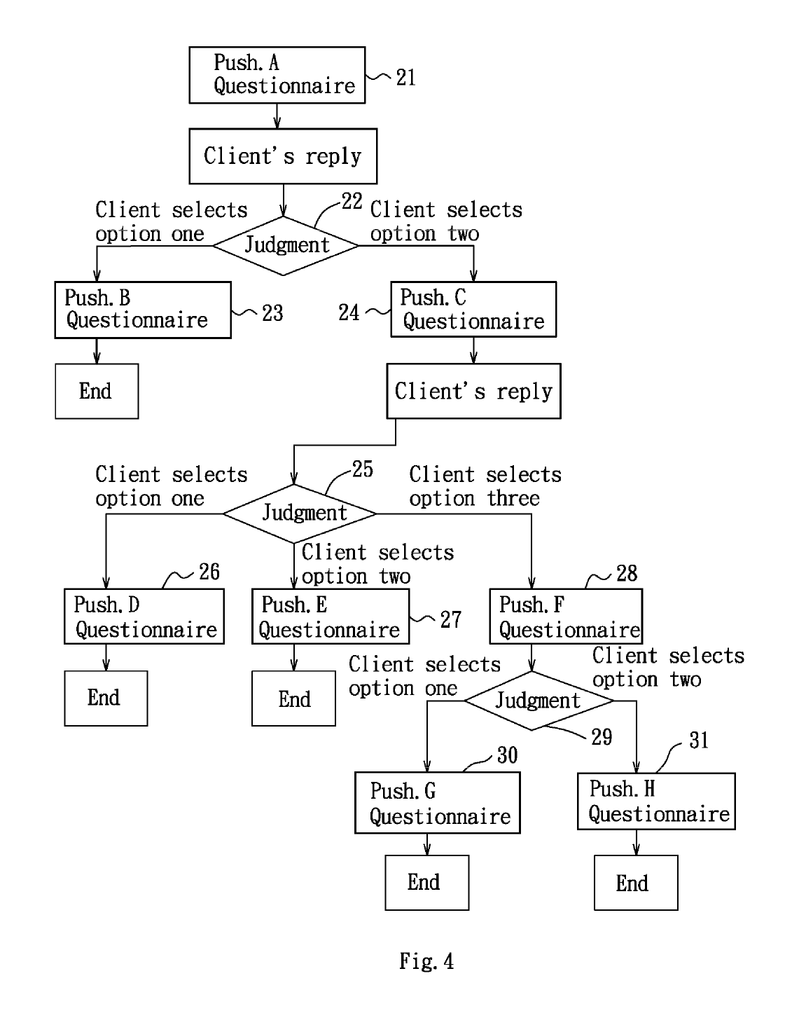

Referring to FIGS. 1 and 4, the push message of this embodiment is adopted with a universal network protocol and an extensible markup language format. The push message provides a plurality of options for a user to select, a selected option is sent to the servo system, and the servo system provides a next push message according to the selected option. Accordingly, a multi-layered structural questionnaire can be executable, and the questionnaire to the user can be completed by the portable electronic device anywhere anytime.

Specifically, the servo system sends a first push message of code Push. A questionnaire (step 21), receives and judges a user's replied message (step 22). If the user selects “Option One”, the servo system sends a second push message of code Push. B questionnaire (step 23). If the user selects “Option Two”, the servo system sends a second push message of code Push. C questionnaire (step 24). Assumed that there is next option(s) after the Push. C questionnaire in the design of questionnaire, it is possible that the servo system receives a user's replied message after step 24 and judges a user's selected option (step 25). If the user selects “Option One”, the servo system sends a third push message of code Push. D questionnaire (step 26). If the user selects “Option Two”, the servo system sends a third push message of code Push. E questionnaire (step 27). If the user selects “Option Three”, the servo system sends a third push message of code Push. F questionnaire (step 28). Assumed that there is next option(s) after the Push. F questionnaire in the design of questionnaire, it is possible that the servo system receives a user's replied message after step 28 and judges a user's selected option (step 29). If the user selects “Option One”, the servo system sends a fourth push message of code Push. G questionnaire (step 30). If the user selects “Option Two”, the servo system sends a fourth push message of code Push. H questionnaire (step 31).

Because the users who favor particular types of high-level smart mobile phones are usually referred to a particular group having favorite information in common, it is therefore that the advertisers can utilize the invention to accurately send information to the particular group of users.

In conclusion, the invention provides an information transmission method and a servo system based on the classification of the electronic device, thereby greatly increasing accuracy and hit rate of the marketing messages, preventing users from receiving uninterested information, and advancedly applying on the execution of the questionnaire. Accordingly, the invention can surely attain the above-described purposes.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An information transmission method based on a classification of an electronic device, comprising:
(A) providing an application program to be downloaded, installed and executed in the electronic device, in which, after the electronic device executes the application program and a consent key is pressed, a device datum comprising the classification of the electronic device is sent to a servo system;
(B) recording the device datum in a user database; and
(C) pushing a push message corresponding to the classification of the electronic device to the electronic device.

2. The information transmission method based on the classification of the electronic device as claimed in claim 1, wherein in step (A), after the application program is executed and the consent key is pressed, the electronic device sends positioning information along with time to the servo system; and in step (C) the push message pushed to the electronic device further corresponds to a position range determined in accordance with the positioning information.

3. The information transmission method based on the classification of the electronic device as claimed in claim 2, prior to step (C), further comprising step (D-1) of providing an information sending operation interface for an information sender to determine the position range to produce a range result, and step (D-2) of receiving the range result, wherein in step (C), the electronic device is located within the position range and the push message is pushed to the electronic device within the position range.

4. The information transmission method based on the classification of the electronic device as claimed in claim 1, wherein in step (C) the push message is firstly transmitted to an electronic device supplier, and then the electronic device supplier

5. The information transmission method based on the classification of the electronic device as claimed in claim 1, wherein the push message is adopted with a universal network protocol and an extensible markup language format.

6. The information transmission method based on the classification of the electronic device as claimed in claim 5, wherein the push message provides a plurality of options for a user to select, a selected option is sent to the servo system, and the servo system provides a next push message according to the selected option.

7. A servo system, executing the information transmission method based on the classification of the electronic device as claimed in claim 1.
